(19) United States
(12) Patent Application Publication
(10) Pub. No.: US 2012/0087011 A1
(43) Pub. Date: Apr. 12, 2012

(54) LIGHT TRANSMITTANCE ADJUSTMENT LAYER, LIGHT TRANSMITTANCE ADJUSTMENT GLASS, AND GLASS FOR WINDOW

(76) Inventors: Dong-Gun Moon, Yongin-si (KR); Myun-Gi Shim, Yongin-si (KR); Mi-Hyun Lee, Yongin-si (KR); Soo-Ho Park, Yongin-si (KR); Tae-Hyun Bae, Yongin-si (KR)

(21) Appl. No.: 13/076,154

(22) Filed: Mar. 30, 2011

(30) Foreign Application Priority Data
Oct. 12, 2010 (KR) 10-2010-0099540

(51) Int. Cl. G02B 1/11

(52) U.S. Cl. 359/601

(57) ABSTRACT

A light transmittance adjustment layer configured to be coupled to a glass substrate for windows, the light transmittance adjustment layer including a plurality of light blocking layers therein, the plurality of light blocking layers spaced apart from and substantially parallel to one another in a direction substantially perpendicular to a surface of the light transmittance adjustment layer, wherein intervals between the plurality of light blocking layers and heights of the plurality of light blocking layers are arranged such that (90°−latitude−23.5)<(interval/height)<(90°−latitude+23.5°−15°), and wherein the latitude corresponds to a region in which the light transmittance adjustment layer is installed.

### RELATED APPLICATIONS

This application claims the benefit of Korean Patent Application No. 10-2010-0099540, filed on Oct. 12, 2010, in the Korean Intellectual Property Office, the disclosure of which is incorporated herein in its entirety by reference.

### BACKGROUND

1. Field

One or more embodiments of the present invention relate to light transmittance adjustment layers and light transmittance adjustment glasses for windows, and glasses for windows.

2. Description of Related Art

In general, windows transmit sunlight incident from the outside indoors using a transparent material, such as glass, and block heat indoors from flowing to the outside. As such, windows provide a heating effect using sunlight. Furthermore, an outflow of heat from the inside to the outside may be prevented or reduced, thereby increasing the heating effect.

### SUMMARY OF THE INVENTION

One or more embodiments of the present invention include light transmittance adjustment layers for windows for adjusting light transmittance according to solar altitude, light transmittance adjustment glass, and glass for windows.

One or more embodiments of the present invention include light transmittance adjustment layers for windows for adjusting light transmittance according the season, a light transmittance adjustment glass, and a glass for windows.

According to one or more embodiments of the present invention, a light transmittance adjustment layer configured to be coupled to a glass substrate for windows includes a plurality of light blocking layers therein, the plurality of light blocking layers spaced apart from and substantially parallel to one another in a direction substantially perpendicular to a surface of the light transmittance adjustment layer, wherein intervals between the plurality of light blocking layers and heights of the plurality of light blocking layers are arranged such that (90°−latitude−23.5°)<(interval/height)<(90°−latitude+23.5°), and wherein the latitude corresponds to a region in which the light transmittance adjustment layer is installed.

The intervals between the plurality of light blocking layers and the heights of the plurality of light blocking layers may be arranged such that (90°−latitude)<(interval/height)<(90°−latitude+23.5°−15°).

The intervals between the plurality of light blocking layers and the heights of the plurality of light blocking layers may be arranged such that (90°−latitude−23.5°)<(interval/height)<(90°−latitude+23.5°−15°).

Respective thicknesses of the plurality of light blocking layers may be equal to or less than 20 μm. The intervals between adjacent ones of the plurality of light blocking layers may be equal to or greater than 100 μm and equal to or less than 300 μm. Respective heights of the plurality of light blocking layers may be equal to or less than 300 μm.

The light transmittance adjustment layer may include at least one of polyethylene terephthalate (PET), triacetyl cellulose (TAC), acryl, or a silicon oxide.

The plurality of light blocking layers may include a mixture of a block colorant and a binder. The black colorant may include carbon black. The binder may include at least one of an acryl binder or a transparent resin.

The light transmittance adjustment layer may further include a reflection layer on each of the plurality of light blocking layers.

According to one or more embodiments of the present invention, the light transmittance adjustment layer may be coupled to a glass substrate to form a glass for a window.

According to one or more embodiments of the present invention, a light transmittance adjustment glass includes: a glass substrate; and a plurality of light blocking layers in the glass substrate and spaced apart from and substantially parallel to one another in a direction substantially perpendicular to a surface of the glass substrate, wherein intervals between the plurality of light blocking layers and heights of the plurality of light blocking layers are arranged such that (90°−latitude−23.5°)<(interval/height)<(90°−latitude+23.5°−15°), and wherein the latitude corresponds to a region in which the light transmittance adjustment glass is installed.

### BRIEF DESCRIPTION OF THE DRAWINGS

These and/or other aspects will become apparent and more readily appreciated from the following description of the embodiments, taken in conjunction with the accompanying drawings, of which:

FIGS. 1A and 1B illustrate a structure of a glass for windows, according to an embodiment of the present invention;

FIG. 2 is a cross-sectional view illustrating a structure of a light transmittance adjustment glass according to an embodiment of the present invention;

FIG. 3 is a schematic view for explaining effects of a light transmittance adjustment layer and a light transmittance adjustment glass according to an embodiment of the present invention;

FIG. 4 is a graph showing light transmittance of light blocking units with respect to solar altitude according to an embodiment of the present invention;

FIGS. 5A and 5B are schematic views for explaining a difference in light transmittance according to a length of intervals of a plurality of light blocking layers, according to an embodiment of the present invention;

FIGS. 6A and 6B are schematic views for explaining a difference in light transmittance according to the height of the light blocking layers;

FIG. 7 is a graph showing light transmittance of a light transmittance adjustment layer or a light transmittance adjustment glass having a lower or shorter height than that of the graph of FIG. 4 with respect to solar altitude;

FIG. 8 shows variation in light transmittance according to sunlight according to atan value (interval/height) of a plurality of light blocking layers; and

FIG. 9 is a cross-sectional view illustrating a structure of a light transmittance adjustment layer or a glass for windows according to another embodiment of the present invention.

### DETAILED DESCRIPTION OF THE EMBODIMENTS

Reference will now be made in detail to embodiments of the invention, examples of which are illustrated in the accompanying drawings, wherein like reference numerals refer to like elements throughout. In this regard, the present embodiments may have different forms, and should not be construed as being limited to the descriptions set forth herein. Accordingly, the embodiments are merely described below, in reference to the figures, to explain aspects of the present description.

The description below and the attached drawings are provided to gain understanding of operations according to embodiments of the present invention. Description of elements or operations which may be easily implemented by one of ordinary skill in the art may be omitted.

The invention should not be limited to the provided description and/or drawings.

Hereinafter, embodiments of the present invention will be described with reference to the attached drawings.

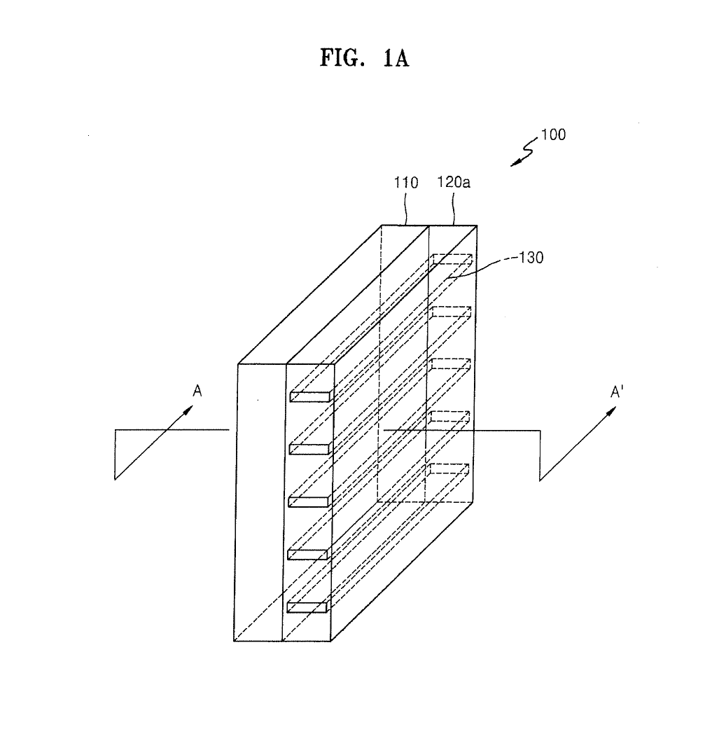

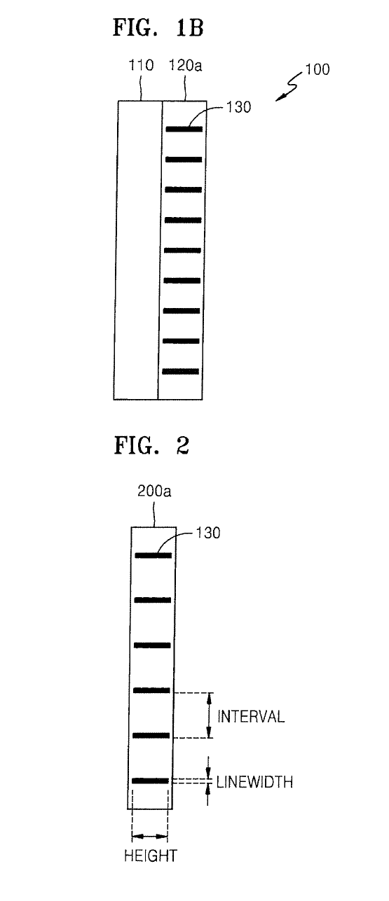

FIG. 1A is a perspective view illustrating a glass 100 for windows, according to an embodiment of the present invention. FIG. 1B is a cross-sectional view of the glass 100 of FIG. 1A, taken along a direction A-A′.

The glass 100 includes a glass substrate 110 and a light transmittance adjustment layer 120a.

The glass substrate 110 may be any glass that is substantially transparent and substantially flat, and the material, thickness, size, and shape of the glass substrate 110 may be selected according to purpose or application. The glass substrate 110 is, for example, a window glass.

The light transmittance adjustment layer 120a is coupled to the glass substrate 110 in a stack. The light transmittance adjustment layer 120a may be stacked on the glass substrate 110 so as to form a single unit. Alternatively, the light transmittance adjustment layer 120a may be an adhesive film. The light transmittance adjustment layer 120a includes a plurality of light blocking layers 130 and a medium filling in spaces between the light blocking layers 130. The medium may include at least one of polyethylene terephthalate (PET), triacetyl cellulose (TAC), acryl, and a silicon oxide, or a mixture of these.

In detail, the light transmittance adjustment layer 120a includes the light blocking layers 130 that are spaced apart from and substantially parallel to one another in a direction substantially perpendicular to a surface of the light transmittance adjustment layer 120a. The plurality of light blocking layers 130 of the light transmittance adjustment layer 120a may be equally spaced apart from one another. The plurality of light blocking layers 130 may be formed of a material having either light-absorbing or light-blocking properties. The plurality of light blocking layers 130 may include a mixture of a black colorant and a binder. The black colorant may be, for example, carbon black. The binder may be, for example, at least one of an acrylic binder or a transparent resin, or a mixture of these.

FIG. 2 is a cross-sectional view illustrating a structure of a light transmittance adjustment glass 200a according to an embodiment of the present invention.

The light transmittance adjustment glass 200a is formed of a glass substrate into which a plurality of light blocking layers 130 are inserted. Thus, there is no need to additionally couple the light blocking layers 130 separately to a glass substrate (e.g., as seen in FIGS. 1A and 1B), and the light transmittance adjustment glass 200a may be used independently. The plurality of light blocking layers 130 inserted in the light transmittance adjustment glass 200a are spaced apart from and substantially parallel to one another in a direction substantially perpendicular to a surface of the glass substrate.

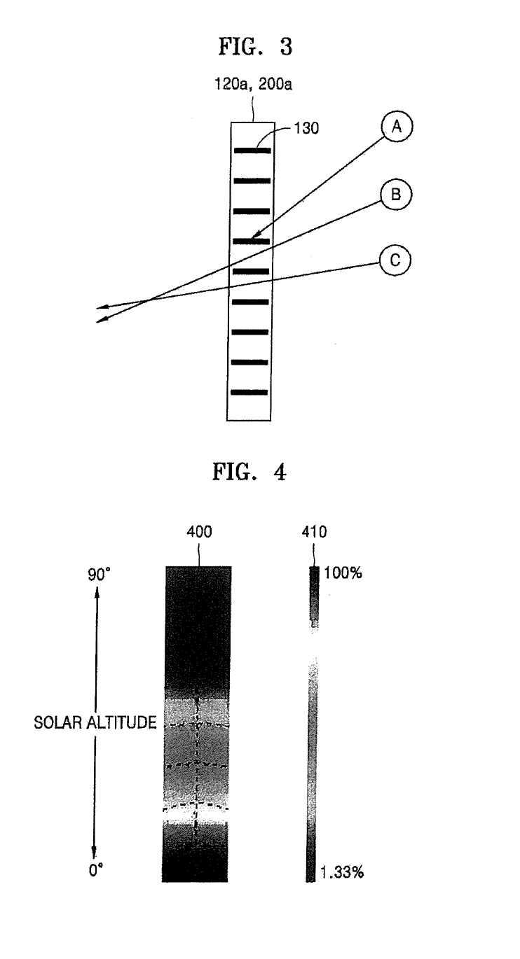

FIG. 3 is a schematic view for explaining the effect of the light transmittance adjustment layer 120a and the light transmittance adjustment glass 200a. The light transmittance adjustment layer 120a and the light transmittance adjustment glass 200a vary light transmittance according to solar altitude (e.g., an angle of incident light towards the light transmittance adjustment layer 120a and/or the light transmittance adjustment glass 200a).

As illustrated in FIG. 3, at a high solar altitude A, incident light is blocked by the plurality of light blocking layers 130 and thus the amount of light transmitted indoors is reduced. In general, the higher the solar altitude, the greater the solar energy and temperature that reaches a ground surface. Thus, to cool a room, it is advantageous to block sunlight from flowing into the room. According to the current embodiment of the present invention, the higher the solar altitude, the lower the light transmittance. Accordingly, cooling efficiency is increased with respect to the higher solar altitude A.

At lower solar altitudes B and C, a rate or amount of incident light blocked by the plurality of light blocking layers 130 is lowered, and a ratio of light being transmitted through the medium and into the room is increased, thereby increasing the light transmittance. Therefore, generally, the lower the solar altitude, the higher the light transmittance. Generally, the lower the solar altitude, the smaller the amount of solar energy that reaches the ground surface, which reduces the temperature of the incident light. Accordingly, it may be advantageous or helpful to transmit more sunlight for heating under these conditions. According to the current embodiment of the present invention, the lower the solar altitude, the higher the light transmittance, thereby increasing the heating effect using the sunlight.

In general, the solar altitude is higher in summer than in winter. Thus, in summer, the amount of solar energy reaching the ground surface is greater than in winter, and thus the temperature is higher and the cooling effect becomes more of a factor. According to the current embodiment of the present invention, in summer when the solar altitude is high, light transmittance is reduced and a light blocking rate is increased, thereby increasing an indoor cooling effect. Meanwhile, in winter, the solar altitude is lower and the amount of solar energy that reaches the ground surface is smaller than in the summer, and thus the temperature is lower and the heating effect becomes more of a factor. According to the current embodiment of the present invention, in winter when the solar altitude is lower, light transmittance is increased and thus an indoor heating effect is increased.

FIG. 4 is a graph illustrating light transmittance of light blocking units with respect to solar altitude according to an embodiment of the present invention.

A left graph 400 shows light transmittance of a light blocking unit according to solar altitude, according to the current embodiment of the present invention. The graph 400 of FIG. 4 shows light transmittance in a light blocking unit including light blocking layers 130 having, for example, a line width of 15 μm, an interval of 120 μm, and a height of 200 μm. The line width, interval, and height are defined in FIG. 2. The line width refers to a thickness of the light blocking layers 130, the interval refers to a distance between the plurality of light blocking layers 130, and the height refers to a length of the light blocking layers 130. The light transmittance is shown by colors in the graph 400 of FIG. 4, and each color denotes a ratio of light transmittance with respect to a maximum amount of transmitted light as shown in a right graph 410. As illustrated in the graph 400, the light blocking units provide lower light transmittance when the solar altitude is higher, and higher light transmittance when the solar altitude is lower.

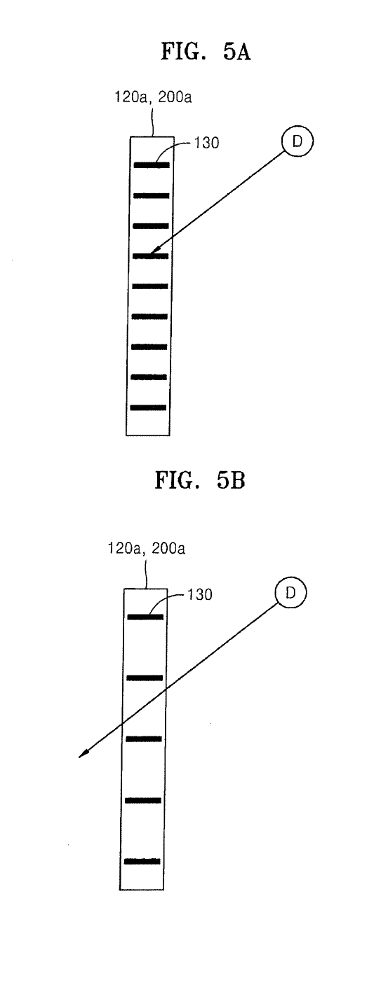

FIGS. 5A and 5B are schematic views for explaining differences in light transmittance according to a length of intervals between the plurality of light blocking layers 130, according to an embodiment of the present invention.

In the light blocking structure according to the current embodiment of the present invention, light transmittance may vary according to intervals between the plurality of light blocking layers 130. As illustrated in FIGS. 5A and 5B, at a predetermined solar altitude D, the smaller the intervals are between the light blocking layers 130, the higher the probability that sunlight is blocked by the plurality of light blocking layers 130, thereby reducing the light transmittance. On the other hand, at the predetermined solar altitude D, the greater the intervals are between the plurality of light blocking layers 130, the lower the probability that sunlight is blocked by the plurality of light blocking layers 130, thereby increasing the light transmittance.

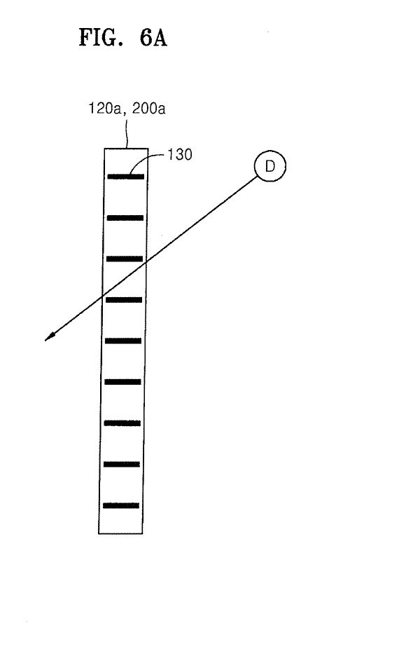

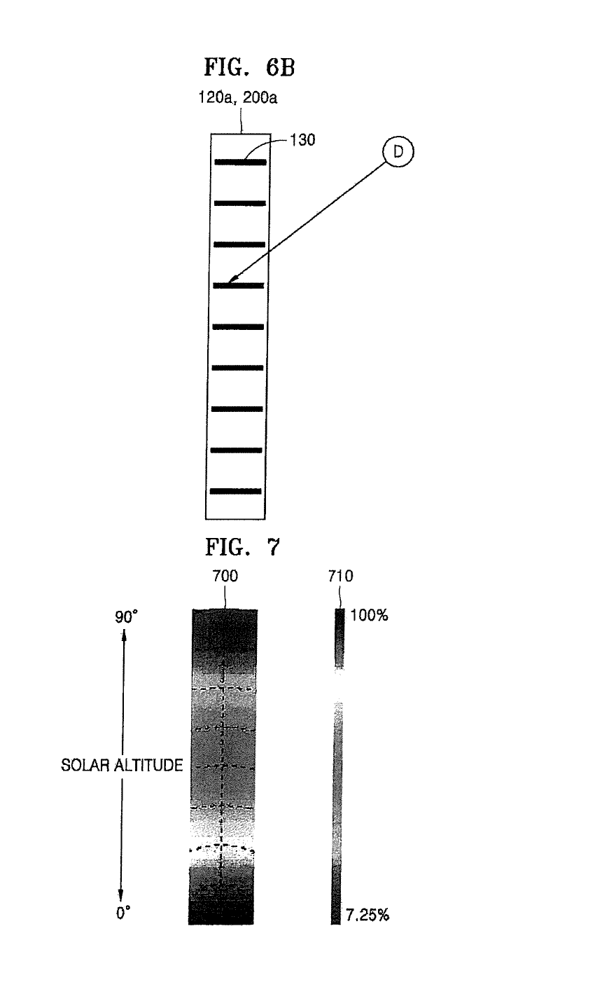

FIGS. 6A and 6B are schematic views for explaining differences in light transmittance according to heights (e.g., lengths) of the light blocking layers 130.

In the light blocking structure according to the current embodiment of the present invention, light transmittance may vary according to the heights or lengths of the plurality of light blocking layers 130. As illustrated in FIGS. 6A and 6B, at a predetermined solar altitude D, the lower the heights the plurality of light blocking layers 130 are, the lower the probability that sunlight is blocked by the plurality of light blocking layers 130, thereby increasing the light transmittance. Meanwhile, the higher the heights the plurality of light blocking layers 130 are, the higher the probability that sunlight is blocked by the plurality of light blocking layers 130, thereby reducing the light transmittance.

FIG. 7 is a graph showing light transmittance of a light transmittance adjustment layer 120a or a light transmittance adjustment glass 200a having a lower or shorter height (e.g., length) than that of the graph of FIG. 4 with respect to solar altitude.

FIG. 7 is a graph showing light transmittance of a light blocking structure including a plurality of light blocking layers having a line width of 15 μm, an interval of 120 μm, and a height of 100 μm. The line width and the interval in FIG. 7 are the same as those of the graph of FIG. 4, while the height of the light blocking layers 130 in FIG. 7 is half the height of the light blocking layers used for the graph of FIG. 4. As illustrated in FIG. 7, the light transmittance of the light blocking structure according to the current embodiment is greater at a predetermined solar altitude D when compared to the graph of FIG. 4, for example, as the height of the light blocking layers 130 are decreased.

As described above, light transmittance in the light blocking structure varies as the interval and height of the light blocking layers varies. Tables 1 and 2 below show light transmittance according to intervals and heights of the light blocking layers 130, in reference with latitude and solar altitude.

TABLE 1

| Latitude | |
|---|---|
| Latitude 20 | Latitude 30 |

Sun altitude

| | | Max | Min | Max | Min |
|---|---|---|---|---|---|
| Interval | Height | 90 | 46.5 | 83.5 | 36.5 |
| 100 | 30 | 0.23 | 2.36 | 0.23 | 4.88 |
| 100 | 40 | 0.22 | 2.29 | 0.22 | 4.73 |
| 100 | 50 | 0.22 | 2.22 | 0.22 | 4.58 |
| 150 | 30 | 0.3 | 3.03 | 0.3 | 6.25 |
| 150 | 40 | 0.29 | 2.95 | 0.29 | 6.1 |
| 150 | 50 | 0.28 | 2.88 | 0.28 | 5.95 |
| 200 | 30 | 0.36 | 3.69 | 0.36 | 7.62 |
| 200 | 40 | 0.35 | 3.61 | 0.35 | 7.47 |
| 200 | 50 | 0.35 | 3.54 | 0.35 | 7.31 |
| 300 | 30 | 0.49 | 5.01 | 0.49 | 10.35 |
| 300 | 40 | 0.48 | 4.94 | 0.48 | 10.2 |
| 300 | 50 | 0.47 | 4.86 | 0.47 | 10.05 |

TABLE 2

| Latitude | |
|---|---|
| Latitude 37.6 | Latitude 50 |

Sun altitude

| | | Max | Min | Max | Min |
|---|---|---|---|---|---|
| Interval | Height | 75.9 | 28.9 | 63.5 | 16.5 |
| 100 | 30 | 0.62 | 17.56 | 1.24 | 36.51 |
| 100 | 40 | 0.6 | 17.01 | 1.21 | 35.37 |
| 100 | 50 | 0.58 | 16.46 | 1.17 | 34.23 |
| 150 | 30 | 0.79 | 22.47 | 1.59 | 46.72 |
| 150 | 40 | 0.77 | 21.92 | 1.55 | 45.58 |
| 150 | 50 | 0.75 | 21.37 | 1.51 | 44.45 |
| 200 | 30 | 0.97 | 27.38 | 1.94 | 56.94 |
| 200 | 40 | 0.95 | 26.83 | 1.9 | 55.8 |
| 200 | 50 | 0.93 | 26.28 | 1.86 | 54.66 |
| 300 | 30 | 1.31 | 37.2 | 2.64 | 77.36 |
| 300 | 40 | 1.29 | 36.65 | 2.6 | 76.23 |
| 300 | 50 | 1.27 | 36.11 | 2.56 | 75.09 |

As shown in Tables 1 and 2, in low latitude regions, solar altitude is relatively high, and thus light transmittance is relatively lower, whereas in high latitude regions, solar altitude is relatively low, and thus light transmittance is relatively higher. Accordingly, in low latitude regions, for example, in warmer or more tropical climates, relatively greater cooling effect may be achieved through the light blocking effect, while in high latitude regions, for example in colder climates, relatively greater heating effect through sunlight may be achieved with the increased light transmittance.

In addition, as shown in Tables 1 and 2, light transmittance may be adjusted by adjusting the intervals and the heights of the light blocking layers. The light blocking structure according to the current embodiment of the present invention may be applicable to windows, and to prevent or reduce blocking views through the windows, the thickness of the plurality of the light blocking layers 130 may, for example, be greater than 0 μm and equal to or less than 20 μm. The intervals between the plurality of light blocking layers 130 may be 100 μm or greater in order to maintain at least 30% of light transmittance in lower solar altitudes such as 10 to 20 degrees, and 300 μm or less to retain some light blocking effects. The height of the light blocking layers 130 according to the current embodiment of the present invention may be, for example, 300 μm or less.

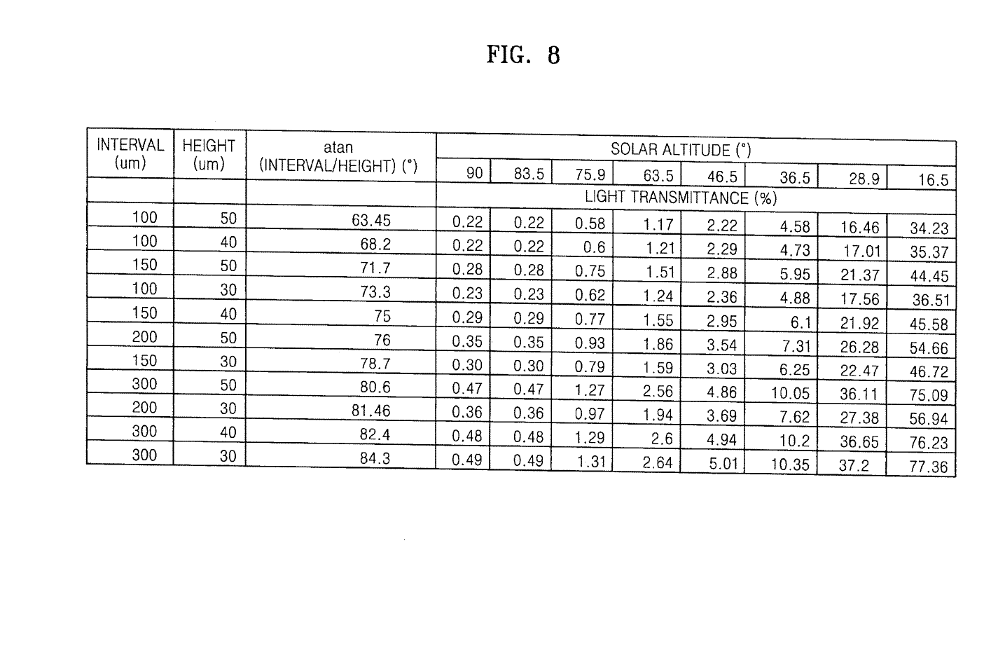

FIG. 8 shows variation in light transmittance of the plurality of light blocking layers 130 according to sunlight and atan values (interval/height).

As illustrated in FIG. 8, the greater the atan value (interval/height), the greater the total light transmittance, and the smaller the atan value (interval/height), the lower the total light transmittance. According to the current embodiment of the present invention, by adjusting a relationship between the intervals and heights of the plurality of light blocking layers 130, greater light blocking effects may be obtained at or above a predetermined solar altitude, while greater light transmittance may be obtained at or below the predetermined solar altitude. Referring to FIG. 8, light transmittance is generally 5% or less at solar altitudes higher than a particular atan value (interval/height), and light transmittance generally increases as the solar altitude is lowered.

According to the current embodiments of the present invention, the atan value (interval/height) may be adjusted to vary light transmittance according to the seasons of the year. The meridian altitude of the sun varies according to latitudes and seasons. The meridian altitude of the sun can generally be determined in each solar term as follows.

The Meridian Altitude of the Sun:

Spring equinox, autumnal equinox: 90°−latitude

Summer solstice: 90°−latitude+23.5°

Winter solstice: 90°−latitude−23.5°

According to an embodiment of the present invention, an atan value (interval/height) may be determined to satisfy the following inequality.

(90°−latitude−23.5°)<atan value (interval/height)<(90°−latitude+23.5°) (1)

According to the current embodiment, the atan value (interval/height) is set to be less than the meridian altitude of the summer solstice, which is the highest altitude of the year, thereby reducing light transmittance in warmer seasons when the solar altitude approaches the meridian altitude of the summer solstice. Furthermore, according to the current embodiment, the atan value (interval/height) is set to be higher than the meridian altitude of the winter solstice, which is the lowest altitude of the year, thereby increasing light transmittance in colder seasons when the meridian altitude of the sun is generally lower.

Alternatively, the atan value (interval/height) may be determined to satisfy the following inequality.

(90°−latitude)<atan value (interval/height)<(90°−latitude+23.5°−15°) (2)

Alternatively, the atan value (interval/height) may be set to be less than a value obtained by subtracting 15° from the meridian altitude of the summer solstice. The sun moves by approximately 15° an hour, and the highest temperature of a day usually occurs one or two hours after the sun has passed the meridian altitude. According to the current embodiment, the atan value (interval/height) may be set to be less than the value obtained by subtracting 15° from the meridian altitude of the summer solstice so that light transmittance is maintained to be less than 5% in an approximate time range during which the most intense heat at the summer solstice, and just before and after the summer solstice, in warmer seasons occurs. In addition, according to the current embodiment, by adjusting the atan value (interval/height) to be greater than the meridian altitude of the spring equinox or the autumnal equinox, an excessive reduction in light transmittance (e.g., to 2% or less) may be prevented or reduced until approximately the spring equinox or the autumnal equinox, when temperatures become warmer and cooling effects become more important.

Alternatively, the atan values (interval/height) may be determined to satisfy the following inequality.

(90°−latitude−23.5°)<atan value (interval/height)<(90°−latitude+23.5°−15°) (3)

According to the current embodiment, the atan value (interval/height) is set to be less than the value obtained by subtracting 15° from the meridian altitude of the summer solstice so that light transmittance is maintained to be less than 5% in an approximate time range during the most intense heat at the summer solstice, and just before and after the summer solstice, in warmer seasons. Furthermore, according to the current embodiment, the atan value (interval/height) is set to be higher than that at the meridian altitude of the winter solstice, which is the lowest altitude of the year, thereby increasing the light transmittance in colder seasons when the meridian altitude of the sun is lower.

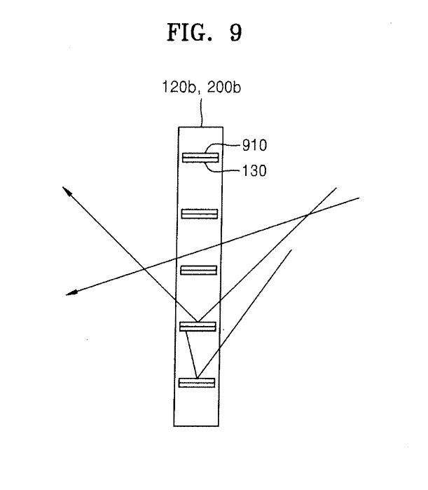

FIG. 9 is a cross-sectional view illustrating a structure of a light transmittance adjustment layer 120b or a light transmittance adjustment glass 200b according to another embodiment of the present invention.

According to this embodiment of the present invention, a reflection layer 910 is stacked on each of the light blocking layers 130. The reflection layer 910 may be formed using a metal having high reflectivity. According to the current embodiment, the reflection layer 910 is formed on the light blocking layer 130, thereby further increasing light transmittance, compared to a structure not including the reflection layer 910.

According to embodiments of the present invention, light transmittance is adjusted according to solar altitude, thereby increasing cooling and/or heating efficiency accordingly.

In addition, according to embodiments of the present invention, light transmittance is adjusted according to the season, thereby providing appropriate light transmittance for each season of the year.

While this invention has been particularly shown and described with reference to certain exemplary embodiments, it will be understood by those of ordinary skill in the art that various changes in form and details may be made without departing from the spirit and scope of the invention as defined by the appended claims. The exemplary embodiments should be considered in descriptive sense only, and not for purposes of limitation. Therefore, the scope of the invention is defined not by the detailed description of the invention but by the appended claims, while any differences within this scope should still be construed as being included in the scope of the present invention.

What is claimed is:

1. A light transmittance adjustment layer configured to be coupled to a glass substrate for windows, the light transmittance adjustment layer comprising a plurality of light blocking layers therein, the plurality of light blocking layers spaced apart from and substantially parallel to one another in a direction substantially perpendicular to a surface of the light transmittance adjustment layer, wherein intervals between the plurality of light blocking layers and heights of the plurality of light blocking layers are arranged such that (90°−latitude−23.5°)<(interval/height)<(90°−latitude+23.5°), and wherein the latitude corresponds to a region in which the light transmittance adjustment layer is installed.

2. The light transmittance adjustment layer of claim 1, wherein the intervals between the plurality of light blocking layers and the heights of the plurality of light blocking layers are arranged such that (90°−latitude)<(interval/height)<(90°−latitude+23.5°−15°).

3. The light transmittance adjustment layer of claim 1, wherein the intervals between the plurality of light blocking layers and the heights of the plurality of light blocking layers are arranged such that (90°−latitude−23.5°)<(interval/height)<(90°−latitude+23.5°−15°).

4. The light transmittance adjustment layer of claim 1, wherein respective thicknesses of the plurality of light blocking layers are equal to or less than 20 μm.

5. The light transmittance adjustment layer of claim 1, wherein the intervals between adjacent ones of the plurality of light blocking layers is equal to or greater than 100 μm and equal to or less than 300 μm.

6. The light transmittance adjustment layer of claim 1, wherein the respective heights of the plurality of light blocking layers are equal to or less than 300 μm.

7. The light transmittance adjustment layer of claim 1, wherein the light transmittance adjustment layer comprises at least one of polyethylene terephthalate (PET), triacetyl cellulose (TAC), acryl, or a silicon oxide.

8. The light transmittance adjustment layer of claim 1, wherein the plurality of light blocking layers comprise a mixture of a block colorant and a binder.

9. The light transmittance adjustment layer of claim 8, wherein the black colorant comprises carbon black.

10. The light transmittance adjustment layer of claim 8, wherein the binder comprises at least one of an acryl binder or a transparent resin.

11. The light transmittance adjustment layer of claim 1, further comprising a reflection layer on each of the plurality of light blocking layers.

12. A glass for windows comprising:
a glass substrate; and
a light transmittance adjustment layer according to claim 1, wherein the light transmittance adjustment layer is coupled to the glass substrate in a stack structure.

13. A light transmittance adjustment glass comprising:
a glass substrate; and
a plurality of light blocking layers in the glass substrate and spaced apart from and substantially parallel to one another in a direction substantially perpendicular to a surface of the glass substrate,
wherein intervals between the plurality of light blocking layers and heights of the plurality of light blocking layers are arranged such that (90°−latitude−23.5°)<(interval/height)<(90°−latitude+23.5°), and wherein the latitude corresponds to a region in which the light transmittance adjustment glass is installed.

14. The light transmittance adjustment glass of claim 13, wherein the intervals between the plurality of light blocking layers and the heights of the plurality of light blocking layers are arranged such that (90°−latitude)<(interval/height)<(90°−latitude+23.5°−15°).

15. The light transmittance adjustment glass of claim 13, wherein the intervals between the plurality of light blocking layers and the heights of the plurality of light blocking layers are arranged such that (90°−latitude−23.5°)<(interval/height)<(90°−latitude+23.5°−15°).

16. The light transmittance adjustment glass of claim 13, wherein respective thicknesses of the plurality of light blocking layers are equal to or less than 20 μm.

17. The light transmittance adjustment glass of claim 13, wherein the intervals between adjacent ones of the plurality of light blocking layers is equal to or greater than 100 μm and equal to or less than 300 μm.

18. The light transmittance adjustment glass of claim 13, wherein the respective heights of the plurality of light blocking layers are equal to or less than 300 μm.

19. The light transmittance adjustment glass of claim 13, wherein the plurality of light blocking layers comprise a mixture of a block colorant and a binder.

20. The light transmittance adjustment glass of claim 19, wherein the black colorant comprises carbon black.

21. The light transmittance adjustment glass of claim 19, wherein the binder comprises at least one of an acryl binder or a transparent resin.

22. The light transmittance adjustment glass of claim 13, further comprising a reflection layer on each of the plurality of light blocking layers.
